(19) United States
(12) Patent Application Publication
(10) Pub. No.: US 2013/0218663 A1
(43) Pub. Date: Aug. 22, 2013

(54) AFFECT BASED POLITICAL ADVERTISEMENT ANALYSIS

(71) Applicant: Affectiva, Inc., (US)

(72) Inventors: Rana el Kaliouby, Waltham, MA (US); Andrew Edwin Dreisch, San Jose, CA (US); Lynda Radosevich, New York, NY (US); Rosalind Wright Picard, Newtonville, MA (US); Nicholas Langeveld, Darien, CT (US)

(73) Assignee: Affectiva, Inc., Waltham, MA (US)

(21) Appl. No.: 13/856,324

(22) Filed: Apr. 3, 2013

Related U.S. Application Data
(63) Continuation-in-part of application No. 13/153,745, filed on Jun. 6, 2011.
Application No. 13/153,745 is a continuation-in-part of application No. 13/656,642, filed on Oct. 19, 2012.
Application No. 13/656,642 is a continuation-in-part of application No. 13/153,745, filed on Jun. 6, 2011.
Application No. 13/153,745 is a continuation-in-part of application No. 13/297,342, filed on Nov. 16, 2011.
(60) Provisional application No. 61/619,914, filed on Apr. 3, 2012.
(60) Provisional application No. 61/747,651, filed on Dec. 31, 2012.
(60) Provisional application No. 61/789,038, filed on Mar. 15, 2013.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/549,560, filed on Oct. 20, 2011.
(60) Provisional application No. 61/619,914, filed on Apr. 3, 2012.
(60) Provisional application No. 61/703,756, filed on Sep. 20, 2012.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/549,560, filed on Oct. 20, 2011.

(51) Int. Cl. G06Q 30/02

(52) U.S. Cl. CPC G06Q 30/0242
USPC 705/14.41

(57) ABSTRACT

Analysis of the mental states of voters is provided to gauge the effectiveness of political messages. Political advertisements are evaluated as they impact various groups of people. Data is captured for an individual voter or group of voters where the data includes facial information and physiological information. Demographics information can be collected and used as a criterion for rendering the mental states of the voters in a graphical format and is synchronized to the political advertisement. Based on mental state data political advertisements can be optimized and targeted based on political affiliation or political leaning.

### RELATED APPLICATIONS

This application claims the benefit of U.S. provisional patent applications “Affect-Based Political Advertisement Analysis” Ser. No. 61/619,914, filed Apr. 3, 2012, “Optimizing Media Based on Mental State Analysis” Ser. No. 61/747,651, filed Dec. 31, 2012, and “Mental State Analysis Using Blink Rate” Ser. No. 61/789,038, filed Mar. 15, 2013. This application is also a continuation-in-part of U.S. patent application “Mental State Analysis Using Web Services” Ser. No. 13/153,745, filed Jun. 6, 2011 which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. This application is also a continuation-in-part of U.S. patent application “Mental State Analysis of Voters” Ser. No. 13/656,642, filed Oct. 19, 2012 which claims the benefit of U.S. provisional patent applications “Mental State Analysis of Voters” Ser. No. 61/549,560, filed Oct. 20, 2011, “Affect Based Political Advertisement Analysis” Ser. No. 61/619,914, filed Apr. 3, 2012, and “Facial Analysis to Detect Asymmetric Expressions” Ser. No. 61/703,756, filed Sep. 20, 2012 and is a continuation-in-part of U.S. patent application “Mental State Analysis Using Web Services” Ser. No. 13/153,745, filed Jun. 6, 2011 which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. This application is also a continuation-in-part of U.S. patent application “Sharing Affect Across a Social Network” Ser. No. 13/297,342, filed Nov. 16, 2011 which claims the benefit of U.S. provisional patent applications “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, “Baseline Face Analysis” Ser. No. 61/467,209, filed Mar. 24, 2011, and “Mental State Analysis of Voters” Ser. No. 61/549,560, filed Oct. 20, 2011. The foregoing applications are hereby incorporated by reference in their entirety.

### FIELD OF ART

This application relates generally to analysis of mental states and more particularly to affect-based political advertisement analysis.

### BACKGROUND

Evaluation of mental states is key to understanding people and the way in which they react to the world around them. Mental states run a broad gamut from happiness to sadness, from contentedness to worry, and from excited to calm, among numerous other mental states. These mental states are experienced in response to everyday events such as frustration during a traffic jam, boredom while standing in line, and impatience while waiting for a cup of coffee. Individuals may become rather perceptive and empathetic based on evaluating and understanding others' mental states. While an empathetic person may perceive another person's mental state—whether anxious, joyful, or sad—and respond accordingly, automated evaluation of mental states is far more challenging. A person may feel that they perceive another's emotional state quickly and instinctually, with a minimum of conscious effort. Thus, the ability and manner by which a person identifies another person's mental state may be difficult to summarize or communicate.

Many mental states, such as confusion, concentration, and worry, may be identified to aid in the understanding of an individual or group of people. For example, people can collectively respond to an external stimulus with fear or anxiety, such as after witnessing a catastrophe. Likewise, people can collectively respond to external stimulus with happy enthusiasm, such as when their sports team wins a major victory. Certain facial expressions and head gestures may be used to identify a mental state that a person is experiencing. Limited automation has been performed in the evaluation of mental states based on facial expressions. For example, certain physiological conditions—conditions which may provide telling indications of a person's state of mind—are already used in a crude fashion to identify a person's mental state, as seen in an apparatus used for lie detector or polygraph tests.

Some systems for analyzing mental states are currently in use, such as the Facial Action Coding System (FACS), a detailed catalog of unique action units that correspond to independent motions of the face. Traditionally FACS data has been manually collected by an observer of the subject and later analyzed to determine various emotions. Another system in wide use for analyzing mental states is the rating dial. A rating dial is a hardware dial that can be manipulated by a subject to indicate their interest, like/dislike, or other emotion on a scale measured over time. Rating dials have been used for a variety of applications, including monitoring couples' feelings during conversations with each other and monitoring audience reactions during political debates.

### SUMMARY

Analysis of mental states may be performed while voters or potential voters observe political advertisements. The analysis may indicate whether a group of voters will be favorably disposed to a candidate based on advertisements or messaging in general about a candidate. A computer-implemented method for voter analysis is disclosed comprising: collecting mental state data from a plurality of people as they observe political advertisements; analyzing the mental state data to produce mental state information; aggregating mental state information on the plurality of people to produce aggregated mental state information; and analyzing the political advertisements based on the aggregated mental state information.

The method may further comprise clustering responses, to the political advertisements, from the plurality of people based on one or more of candidate preference, political affiliation, or political leanings. The analyzing the political advertisements may include analysis based on demographics. The method may further comprise selecting an advertisement from the political advertisements based on the mental state information and the demographics. The method may further comprise exposing the advertisement to a second population of people. The second population may be chosen based on demographics. The second population may be exclusive of the plurality of people from whom mental state data was collected. The method may further comprise identifying similarities between the plurality of people and a second population of people. The similarities may be based on an emotional profile. The identifying of similarities may be for a subset of the plurality of people and the second population of people. The similarities may include at least one of online and offline behavior. The method may further comprise anticipating a set of responses for the second population. The mental state information from one or more people from the plurality of people may be shared across a social network.

The method may further comprise inferring mental states based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity. The collecting may be part of a voter polling process. The mental state data may include one of a group comprising facial data, physiological data, and accelerometer readings. The facial data may further comprise head gestures. The facial data may include information on one or more of action units, head gestures, smiles, brow furrows, squints, lowered eyebrows, raised eyebrows, and attention. A webcam may be used to capture one or more of the facial data and the physiological data. A webcam may be used for each of the plurality of people. A camera may be used to capture the mental state data on multiple people from the plurality of people. The physiological data may include one of a group comprising electrodermal activity, heart rate, heart rate variability, blink rate, and respiration. The physiological data may be collected without contacting the plurality of people. The aggregated mental state information may include categorization based on valence and arousal. The aggregated mental state information may allow evaluation of a collective mental state of the plurality of people. The aggregated mental state information may be aggregated for multiple demographic groups and the multiple demographic groups include one or more of age, political affiliation, gender, geographic location, income, education, and ethnicity. The method may further comprise rendering an output based on the mental state information. The rendering may include highlighting portions of the political advertisements based on the mental state data collected. The method may further comprise opting in for the collecting of the mental state data. The plurality of people may be in a single audience. The plurality of people may be distributed in multiple locations. The method may further comprise tracking of eyes to identify a portion of the political advertisements for which the mental state data is collected. The method may further comprise analyzing election behavior for the plurality of people on which mental state data was collected. The election behavior may include information on not voting by a subset of the plurality of people. The method may further comprise comparing the mental state data with self-report information collected from the plurality of people. The method may further comprise predicting an advertisement effectiveness for the political advertisements and comparing the predicted advertisement effectiveness with actual voting. The method may further comprise developing norms based on a plurality of advertisements and where the norms are used in the predicting. The method may further comprise optimizing a political advertisement based on the mental state information. The optimizing may include optimizing the political advertisement for a mobile platform. The optimizing the political advertisement may be based on multiple viewings by the plurality of people of the political advertisement.

In embodiments, a computer-implemented method for mental state analysis may comprise: collecting mental state data from a plurality of people as they observe political advertisements; analyzing the mental state data to produce mental state information; and sending the mental state information on the plurality of people to produce aggregated mental state information and for analysis of the political advertisements based on the aggregated mental state information. In some embodiments, a computer-implemented method for mental state analysis may comprise: receiving mental state information from a plurality of people based on their observations of political advertisements; aggregating the mental state information on the plurality of people to produce aggregated mental state information; and analyzing the political advertisements based on the aggregated mental state information. In embodiments, a computer-implemented method for mental state analysis may comprise: receiving aggregated mental state information and analysis of political advertisements, based on the aggregated mental state information collected from a plurality of people; and rendering an output based on the analysis of political advertisements. In some embodiments, a computer program product embodied in a non-transitory computer readable medium for mental state analysis may comprise: code for collecting mental state data from a plurality of people as they observe political advertisements; code for analyzing the mental state data to produce mental state information; code for aggregating mental state information on the plurality of people to produce aggregated mental state information; and code for analyzing the political advertisements based on the aggregated mental state information. In embodiments, a computer system for mental state analysis may comprise: a memory which stores instructions; one or more processors attached to the memory wherein the one or more processors, when executing the instructions which are stored, are configured to: collect mental state data from a plurality of people as they observe political advertisements; analyze the mental state data to produce mental state information; aggregate mental state information on the plurality of people to produce aggregated mental state information; and analyze the political advertisements based on the aggregated mental state information.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for analysis of voters.

FIG. 2 is a diagram for collecting facial responses from a group.

FIG. 3 is a diagram describing capturing facial response to political advertisements.

FIG. 4 is a diagram representing physiological analysis.

FIG. 5 is a graphical rendering of mental state analysis.

FIG. 6 is a graphical rendering with demographic information.

FIG. 7 is a diagram of a system for analyzing voter response.

### DETAILED DESCRIPTION

The present disclosure provides a description of various methods and systems for analyzing people's mental states, particularly where the people are voters or potential voters. Voters may observe political advertisements and candidate interactions while having data collected on their mental states. Computer analysis is performed of facial and/or physiological data to determine mental states of the voters as they observe various types of political advertisements. A mental state may be a cognitive state or an emotional state, both of which can be broadly covered using the term affect. Examples of emotional states include happiness or sadness, while examples of cognitive states include concentration or confusion. Observing, capturing, and analyzing these mental states can yield significant information about voters' reactions to various stimuli. Some terms commonly used in evaluation of mental states are arousal and valence. Arousal is an indication of the amount of activation or excitement of a person. Valence is an indication of whether a person is positively or negatively disposed. Determination of affect may include analysis of arousal and valence. Determination of affect may include analysis of facial data for expressions such as smiles or brow furrowing. Analysis may be as simple as tracking when someone smiles or when someone frowns. Mental states may be identified by embodiments of the present disclosure and may include, but not be limited to, frustration, confusion, disappointment, hesitation, cognitive overload, focusing, engagement, attention, boredom, exploration, confidence, trust, delight, disgust, skepticism, doubt, and satisfaction. Knowledge of the mental states voters are experiencing can provide keen insight during political campaigns.

The present disclosure provides a description of various methods and systems associated with performing analysis of voters' mental states. In this disclosure, the term “voters” comprises voters, likely voters, and eligible voters. Embodiments of the present disclosure provide an automated system and method for analyzing the metal states of voters. Example usages may comprise analyzing the mental state of voters in response to a political advertisement. A candidate interaction may include, but is not limited to, a political debate, a politician's speech, a news report, a campaign appearance, a town hall discussion, and a political advertisement. Various candidate interactions can be incorporated or be made part of political advertisements.

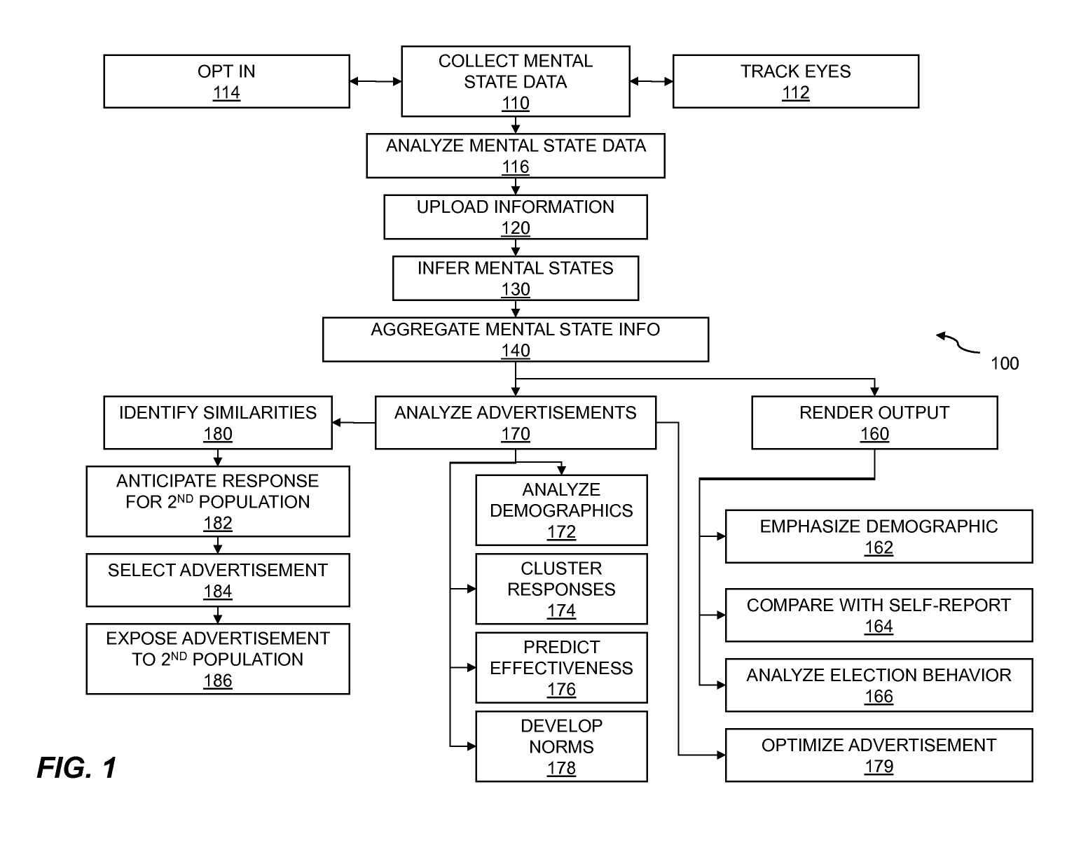

FIG. 1 is a flow diagram for analysis of the mental state of voters. The flow 100 describes a computer implemented method for voter analysis. The flow 100 may begin with collecting mental state data 110 from a plurality of people as they observe political advertisements. The mental state data may include smiles, laughter, smirks, and grimaces. The mental state data may include head positions, up/down head motion, side-to-side head motion, tilting head motion, body leaning motion, and gaze direction. The mental state information may include valence and arousal. The political advertisements may include portions of a debate, a town hall discussion, a campaign appearance, a political advertisement, a message test, and the like. The collecting may be part of a voter polling process. A voter may be asked a series of questions about a candidate or group of candidates. Mental state data may be collected as the voter responds to the questions. The data collected on the individual may include facial expressions, physiological information, and accelerometer readings. The facial expressions may further comprise head gestures. The physiological information may include electrodermal activity, skin temperature, heart rate, heart rate variability, and respiration. In embodiments, data, including physiological data, may be collected without physical contact with an individual voter. A voter may be provided an opt-in option to authorize the collection and analysis of mental state data. The group of voters may be part of a single audience; for example, the group of voters may be in one room watching a political debate. Alternatively, the group of voters may be distributed in multiple locations. In another embodiment, a portion of the group of voters may be in an audience and a portion of the group of voters may be distributed in multiple locations.

The flow 100 may include tracking of eyes 112 to identify a portion of the political advertisement for which the mental state data is collected. Tracking may include determining where in an advertisement window the viewer or viewers' eyes are focused. Tracking may further include dwell time of eyes on a particular location within a rendering. Eye tracking may be observed with a camera and may be used to identify portions of concept renderings viewers may find amusing, annoying, entertaining, distracting, or the like. Eye tracking may be accomplished with a camera such as a webcam, a camera on a computer (such as a laptop, a net-book, a tablet, or the like), a video camera, a still camera, a cell phone camera, a mobile device camera (including, but not limited to, a forward facing camera), a thermal imager, a CCD device, a three-dimensional camera, a depth camera, and multiple webcams used to capture different views of viewers or any other type of image capture apparatus that may allow image data captured to be used by an electronic system. The flow 100 may include opting in 114 before the collecting of mental state data. A voter or group of voters may be asked permission before data collection begins. In one embodiment, an individual may be asked permission to collect mental states prior to viewing or interacting with a rendering. In another embodiment, an individual may be asked permission to collect mental states after the advertisement is viewed. In this case, any information collected on mental states would be discarded if permission was not granted. In another embodiment, an individual may be asked a general question about permission for collecting of mental states prior to viewing or interacting with a rendering and then a confirmation permission requested after the rendering is interacted with or viewed. The intent of these opting in permission requests would be to give the individual control over whether mental states were collected and, further, what type of information may be used. In some embodiments however, no opt-in permission may be obtained or the opt-in may be implicit due to the circumstances of the interaction.

The flow 100 may include analyzing the mental state data 116 to produce mental state information. While mental state information may include raw data such as facial expressions, electrodermal activity, heart rate, heart rate variability, and blink rate it may also include information derived from the raw data. The mental state information may include information on the mental states experienced by the individual. Some embodiments may include inferring mental states based on the collected mental state data.

The flow 100 may include uploading information 120, to a server, based on the mental state data from the plurality of people who observe the political advertisements. In some embodiments, opting in may be performed before the uploading of the information. The uploading may be for the actual data collected, a summary of the data collected, a subset of the data collected, inferred mental states, or the like. Some analyzing may be done on a client computer before the uploading.

The flow 100 may continue with inferring mental states 130 based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity. These mental states may be detected in response to a political advertisement or a specific portion of a political advertisement. The flow 100 may include aggregating information to produce the aggregated mental state information 140 from a plurality of people. The aggregation may be based on demographic groups and the multiple demographic groups include one or more of age, political affiliation, gender, geographic location, income, education, and ethnicity. In embodiments, the aggregation may take place before the inferring of mental states.

The flow 100 continues with receiving aggregated mental state information 150 performed on the plurality of people who observe the political advertisement. The aggregated mental state information may include one of a cognitive state and an emotional state.

The aggregated mental state information may include categorization based on valence and arousal. The aggregated mental state information may allow evaluation of a collective mental state of a plurality of voters. Mental state data may be aggregated from a group of people, i.e. voters, who have observed a particular political advertisement. The aggregated information may be used to infer mental states of a group of voters. This information may allow evaluation of a collective mental state of a group of voters. The group of voters may correspond to a particular demographic, with democrats, women, and people between the ages of 18 and 30, representing examples of specific demographics which could be identified.

The flow 100 continues with analyzing advertisements 170 based on the aggregated mental state information. The advertisements may be for political candidates, services, products, charities, or the like. The analyzing of advertisements may include demographic-based analysis 172. The demographics may include information on gender, age, location, marital status, education, employment status, mobile phone type, and so on. The flow may include clustering responses 174, to the political advertisements, from the plurality of people based on one or more of candidate preference, political affiliation, or political leanings People may be clustered into various groups to facilitate analysis and identify preferences. These preferences may be used in future targeted advertisement development. The flow 100 may include predicting an advertisement effectiveness 176 for the political advertisements and comparing the predicted advertisement effectiveness with actual voting. The flow 100 may include developing norms 178 based on a plurality of advertisements and where the norms are used in the predicting. The flow 100 may include optimizing a political advertisement 179 based on the mental state information. The optimizing may include optimizing the political advertisement for a mobile platform. The optimizing the political advertisement may be based on multiple viewings by the plurality of people of the political advertisement.

The flow may continue with identifying similarities 180 between the plurality of people who observe the political advertisement and a second population of people. The similarities may be based on demographics, behaviors, purchasing history, click-stream history, and the like. The similarities may be based on an emotional profile. The identifying of similarities may not always comprise identifying similarities for an entire group; similarities may be identified for a subset of a plurality of people and a second plurality of people. This identification of similarities may allow the subset of either the first or second population to be targeted for specific advertisements. The identified similarities may include at least one of online and offline behavior. Identifiable online behaviors could include browsing history, online purchase history, mobile device usage, and the like. Various sources of information may be aggregated, including blogs, tweets, social network postings, news articles, and the like. Identifiable offline behaviors could include geographic location, club memberships, volunteer activities, in-store purchases, and so on. The flow 100 may include anticipating a set of responses for the second population 182. The anticipated responses could include favorable responses to candidates, candidate messages, services, products, and the like.

The flow 100 may continue with selecting an advertisement 184 from the political advertisements based on the mental state information and the demographics. The advertisement may be chosen as one that would be memorable due to high affective response. The flow 100 may continue with exposing the advertisement to a second population 186 of people. This second population may be targeted for a specific candidate, candidate message, service, product, or the like. The second population may be chosen based on demographics. The second population may be chosen based on anticipated responses or needs or desires identified within the second population. The second population may be exclusive of the plurality of people from whom mental state data was collected.

The flow 100 continues with rendering an output 160 based on the aggregated mental state information. The aggregated mental state information may be received by a rendering module and may, in turn, be rendered by the rendering module. In one embodiment, the rendering comprises one or more lines on a graph, indicating a particular parameter as a function of time. The rendered output may be customized with various options, for example, a certain demographic could be emphasized 162. This emphasis could prove useful, among other potential uses, in the case of a pollster or political analyst who is interested in observing the mental state of a particular demographic group, such as people of a certain age range or gender. To further corroborate the data, it may also be compared with self-report data 164 collected from the group of voters. In this way, the analyzed mental states can be compared with the self-report information to see how well the two data sets correlate. In some instances, people may self-report a mental state other than their true mental state. For example, in some cases people may self-report a certain mental state because they feel it is the “correct” response or because they are embarrassed to report their true mental state. Comparing collected and analyzed mental state information with self-reported mental state information can serve to identify situations where the analyzed mental state deviates from the self-reported mental state. The flow 100 may include analyzing election behavior 166 for the plurality of people on which mental state data was collected. The election behavior may include, but is not limited to, which candidate the voter voted for, if the voter decided not to participate (i.e. did not vote), or a statement about whether political advertisements influenced a voter's behavior. Thus, the information on election behavior may include information regarding which candidate the plurality of people voted for; alternatively or additionally, the election-behavior information may include information on whether or not a subset of the plurality of people voted at all. Embodiments of the present disclosure may determine a correlation between mental state and election behavior. Various steps in the flow 100 may be changed in order, repeated, omitted, or the like without departing from the disclosed inventive concepts. Various embodiments of the flow 100 may be included in a computer program product embodied in a non-transitory computer readable medium that includes code executable by one or more processors.

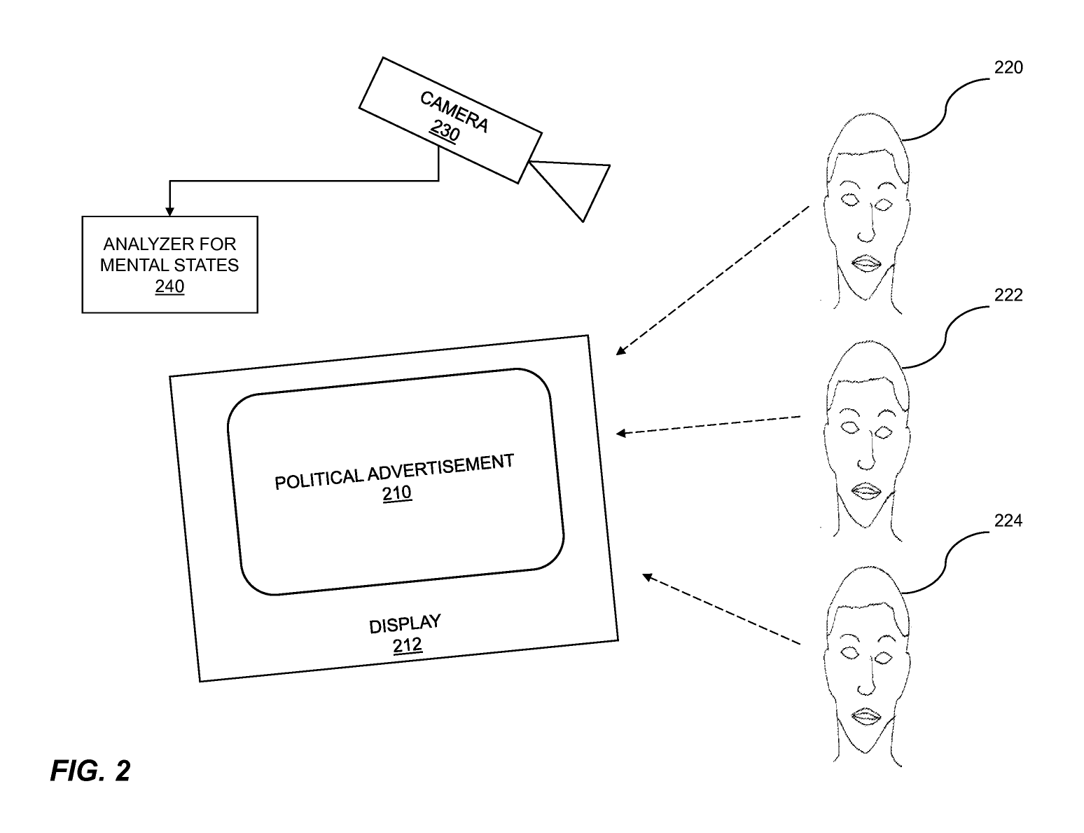

FIG. 2 is a diagram for collecting facial responses from a group. A display 212 such as a television monitor or projection apparatus presents a political advertisement 210 to a group of users. FIG. 2 shows three individual voters, indicated as a first voter 220, a second voter 222, and a third voter 224. While three voters have been shown, in practical use, groups comprising tens, hundreds, thousands, or even more people may be analyzed. The term voters may refer to actual voters, potential voters, audience members, and the like. Each voter watches the political advertisement 210. A political advertisement 210 may include portions of a political debate, a politician's speech, a news report, a campaign appearance, a town hall discussion, a political convention, a political advertisement, and the like. The plurality of people may be in a single audience. The plurality of people may be distributed in multiple locations. In embodiments, the plurality of people is divided, with some of the plurality of people in a local audience and another portion of the plurality of people distributed across multiple locations.

While viewing the political advertisement 210, a camera 230 records facial images of the viewers. The images from the camera 230 are supplied to an analyzer for mental states 240. In embodiments, a webcam is used to capture one or more of the facial data and the physiological data. A camera may be used to capture mental state data on multiple people from the plurality of people. The camera 230 may be a webcam, a camera on a computer (such as a laptop, a net book, a tablet, or the like), a video camera, a still camera, a cell phone camera, a thermal imager, a CCD device, a three-dimensional camera, a depth camera, multiple webcams used to show different views of the voters, or any other type of image capture apparatus that may allow data captured to be used in an electronic system. In embodiments, there may be a camera 230 per viewer of the political. In other embodiments, there may be multiple voters with a single camera 230 observing mental state data as the multiple voters view one or more political advertisements. The analyzer for mental states 240 may comprise one or more processors on one or more computer systems. Embodiments may include various forms of distributed computing, client/server computing, cloud based computing, and the like.

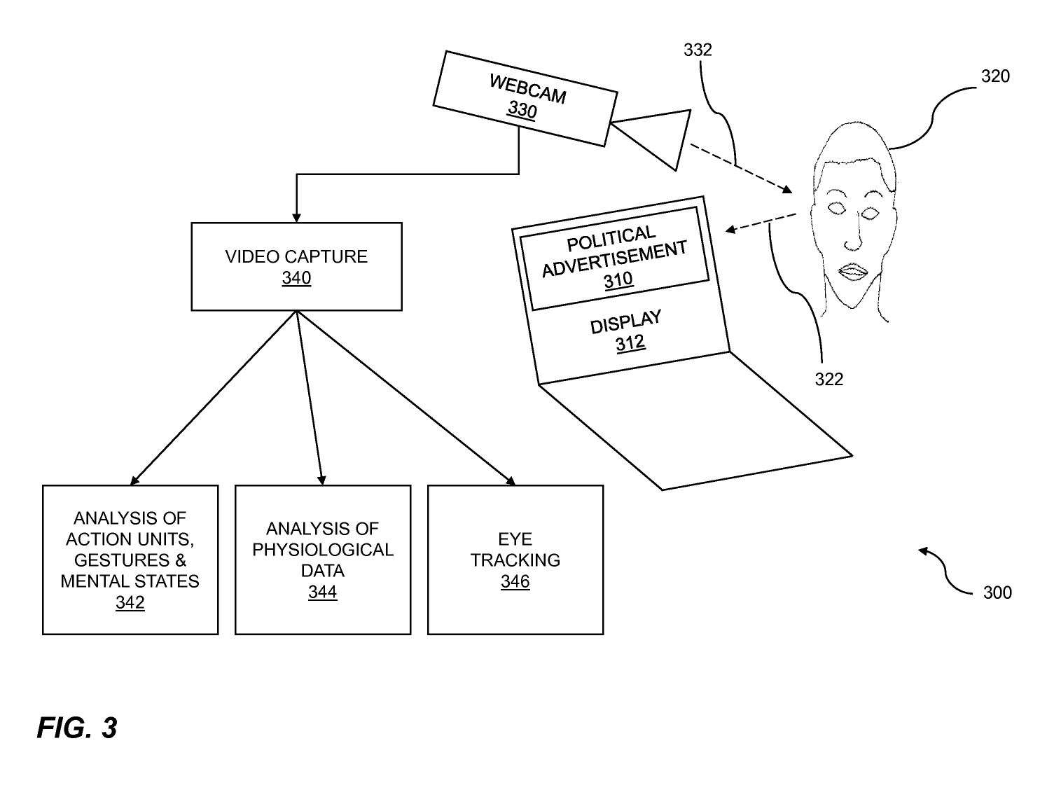

FIG. 3 is a diagram of a system 300 for capturing a facial response to a political advertisement 310. A voter 320 has a line-of-sight 322 to a display 312. The display 312 may be a television monitor, a projector, a computer monitor (including a laptop screen, a tablet screen, a net book screen, and the like), a cell phone display, a mobile device, or another electronic display. The display 312 presents a political advertisement 310 to the voter 320. A webcam 330 is configured and disposed such that it has a line-of-sight 332 to the voter 320. In one embodiment, the webcam 330 is a networked digital camera that may take still and/or moving images of the voter's face 320 and possibly body. The facial data from the webcam 330 is received by a video capture module 340 which may decompress the video into a raw format from a compressed format such as H.264, MPEG-2, or the like. The facial data may include information on action units, head gestures, smiles, brow furrows, squints, lowered eyebrows, raised eyebrows, and attention.

The raw video data may then be processed for analysis of facial data, action units, gestures, and mental states 342. The facial data may further comprise head gestures. The facial data itself may include information on one or more of action units, head gestures, smiles, brow furrows, squints, lowered eyebrows, raised eyebrows, attention, and the like. The action units may be used to identify smiles, frowns, and other facial indicators of mental states. Identified head gestures may include a head tilt to the side, a forward lean, a smile, a frown, or one or more of numerous other facial gestures. Physiological data may be analyzed 344, and eyes may be tracked 346. Physiological data may be obtained through the webcam 330 without contacting the individual. The physiological data may also be obtained by a variety of sensors, such as electrodermal sensors, temperature sensors, and heart rate sensors. The physiological data may include one of a group comprising electrodermal activity, heart rate, heart rate variability, and respiration.

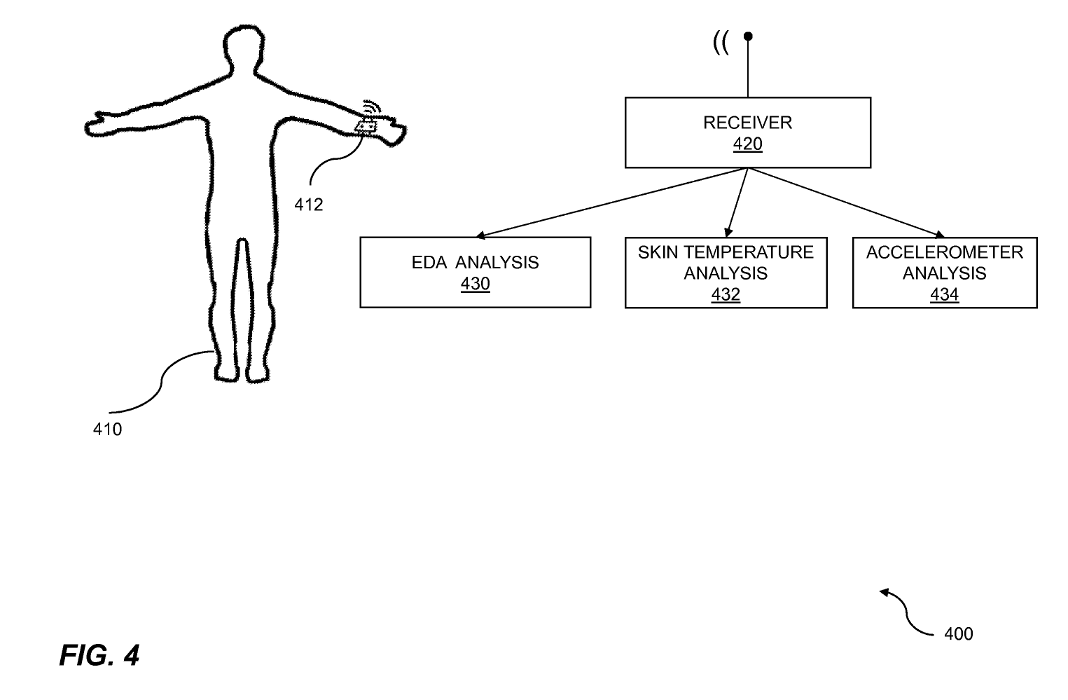

FIG. 4 is a diagram of a system 400 for physiological analysis. A voter 410 may have a sensor 412 attached to him or her for collection of mental state data. The mental state data may include one of a group comprising facial data, physiological data, and accelerometer readings. While FIG. 4 shows a sensor 412 attached to the wrist of the voter 410, in other embodiments the sensor 412 may be attached to the voter's palm, hand, head, sternum, or another part of the voter's body. In some embodiments, multiple sensors are placed on a voter 410 in multiple places; on both wrists, for example. The one or more sensors 412 may include detectors for electrodermal activity, skin temperature, and accelerometer readings. Other detectors may also be included, and may detect physiological signals such as heart rate, blood pressure, and other physiological detectors. The one or more sensors 412 may transmit collected information to a receiver 420 using wireless technology such as Wi-Fi, Bluetooth, 802.11, cellular, or other bands. In some embodiments, the one or more sensors 412 may store information and burst-download the data using wireless technology. In other embodiments, the one or more sensors 412 may store information for later wired download. The data collected by the receiver 420 may be supplied to an electrodermal activity (EDA) analysis module 430, a skin temperature analysis module 432, and an accelerometer analysis module 434. The physiological data, combined with the image data collected in the system shown in FIG. 3, may provide ways to infer the mental state or states of a voter 410.

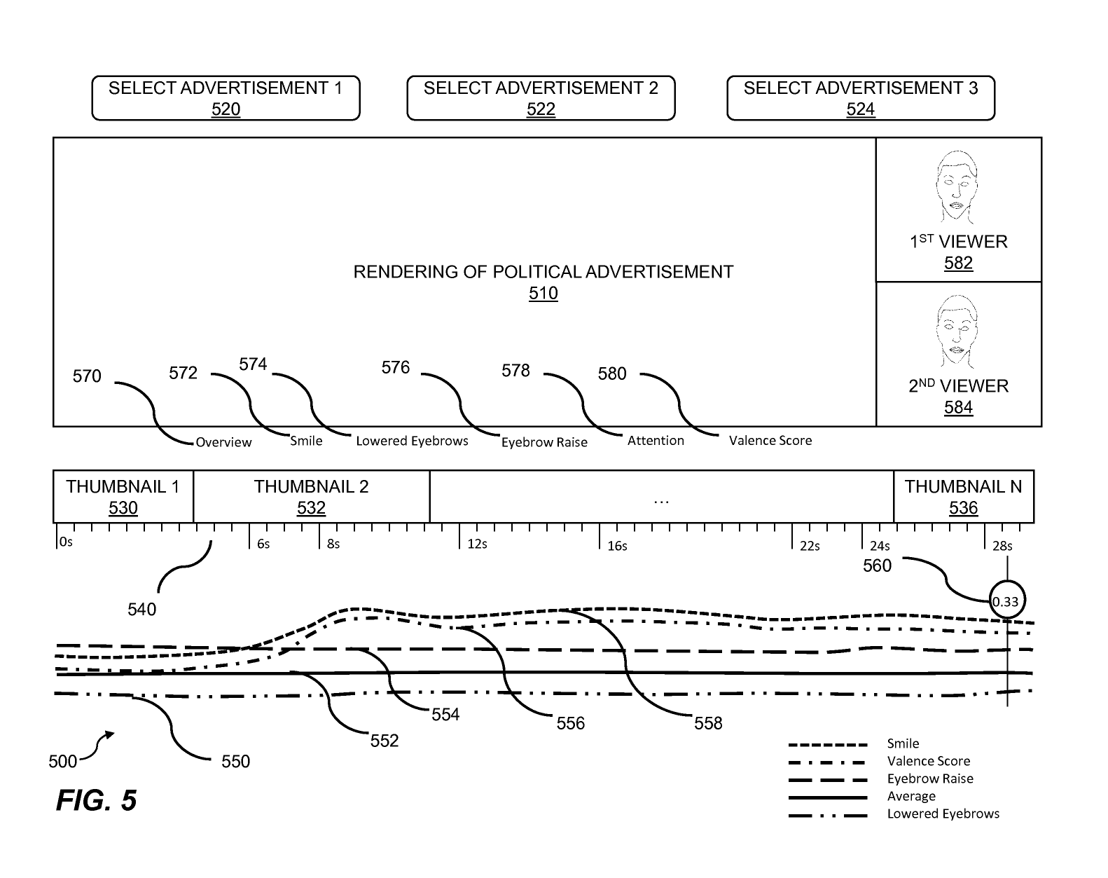

FIG. 5 is a graphical representation of mental state analysis relating to political advertisements. A window 500 may be shown and may include, for example, a rendering of a political advertisement 510 along with associated mental state information. The rendering 510 may include highlighting portions of the political advertisements based on the mental state data collected. The rendering 510 may include a video of a political advertisement. Viewers, such as the first viewer 582 and the second viewer 584, can be shown where their video is synchronized with the video of the political advertisement. A user may be able to select between a plurality of political advertisements using various buttons and/or tabs such as Select Advertisement 1 button 520, Select Advertisement 2 button 522, and Select Advertisement 3 button 524. In other embodiments, a different number of possible selections may be available. In an alternative embodiment, a list box or drop-down menu is used to present a list of political advertisements, each of which, when selected by the user, display as a rendering 510. The user interface allows a plurality of parameters to be displayed as a function of time, synchronized to the political advertisement. Various embodiments may have any number of selections available for the user, some of which may be other types of renderings instead of video. A set of thumbnail images for the selected rendering—in the example shown, thumbnail 1 530, thumbnail 2 532, through thumbnail N 536—may be shown below the rendering along with a timeline 538. The thumbnails may show a graphical “storyboard” of the political advertisement. This storyboard assists a user in identifying a particular scene or location within the political advertisement. Some embodiments may not include thumbnails, or may have a single thumbnail associated with the rendering. Various embodiments may have thumbnails of equal lengths, while other embodiments may have thumbnails of differing lengths. In some embodiments, the start and/or end of the thumbnails may be determined based on changes in the captured mental states associated with the rendering or based on particular points of interest within the political advertisement. In embodiments, points of interest can be automatically identified based on mental state analysis and those points have thumbnails shown. Selection may be possible of those thumbnails and the rendering 510 show that portion that was automatically identified along with videos of the viewers along with mental state analysis. The points of interest may be based on peaks of certain mental states that are identified.

Some embodiments may include the ability for a user to select, using various buttons or other selection methods, a particular type of mental state information for display. As, in the example shown, the smile mental state information is displayed, as the user may have previously selected the Smile button 572. In various embodiments, other types of mental state information may be available for user selection, including information regarding eyebrow raises and lowers, viewer attention, and viewer valence score, among other types of mental state information. In embodiments, this information is available for display by selecting buttons such as the Lowered Eyebrows button 574, the Eyebrow Raise button 576, the Attention button 578, the Valence Score button 580, or another button. An Overview button 570 may be available to allow a user to call up graphs showing multiple types of mental state information simultaneously.

A plurality of graph lines is displayed along a timeline 540. The line 550 may represent lowered eyebrows. Another line 552 may represent an overview and may, in some cases, be an average of other lines. A third line 554 may represent an eyebrow raise. A fourth line 556 may represent a valence score. A fifth line 558 may represent smiling. A time cursor 560 may be used to retrieve the portion of the political advertisement that temporally corresponds to a given point on the curves. The various demographically based graphs may also be shown and may be indicated using various line types—as is the case in FIG. 5—or may be indicated using color or another method of differentiation. A time cursor 560 may allow a user to select a particular time on the timeline and show the value of the chosen mental state for that particular time. The slider may use the same line type or color as is used to differentiate the demographic group whose value is shown. Such demographic groups may be obtained by demographically dividing users on the basis of gender, age, race, income level, or any other type of demographic. In addition, users may be demographically divided into groups of respondents who had higher reactions and groups of respondents who had lower reactions. A graph legend indicating the various demographic groups, the line type or color for each group, the percentage of total respondents and or absolute number of respondents for each group, and/or other information about the demographic groups may be displayed. The mental state information may be aggregated according to the demographic type selected. Thus, in some embodiments, the aggregation of mental state information may be performed on a demographic basis so that mental state information may be grouped based on this demographic aggregation.

As a practical example of such aggregation, a campaign team for a politician may wish to test the effectiveness of a certain political message. The message may be made into a political advertisement, which may then be shown to a plurality of voters in a focus group setting. The campaign team may notice an inflection point in one or more of the curves—for example, a smile line or smirk line may be used to indicate the inflection point. The campaign team can then identify which point in the political advertisement invoked positive reactions from voters. Thus, content can be identified by the campaign as being effective, or at least drawing a positive response. In his manner, voter response can be obtained and analyzed. To this end, the rendering may be accomplished using a dashboard. Rendering the aggregated mental state information may also include highlighting portions of the political advertisement based on the collected mental state data.

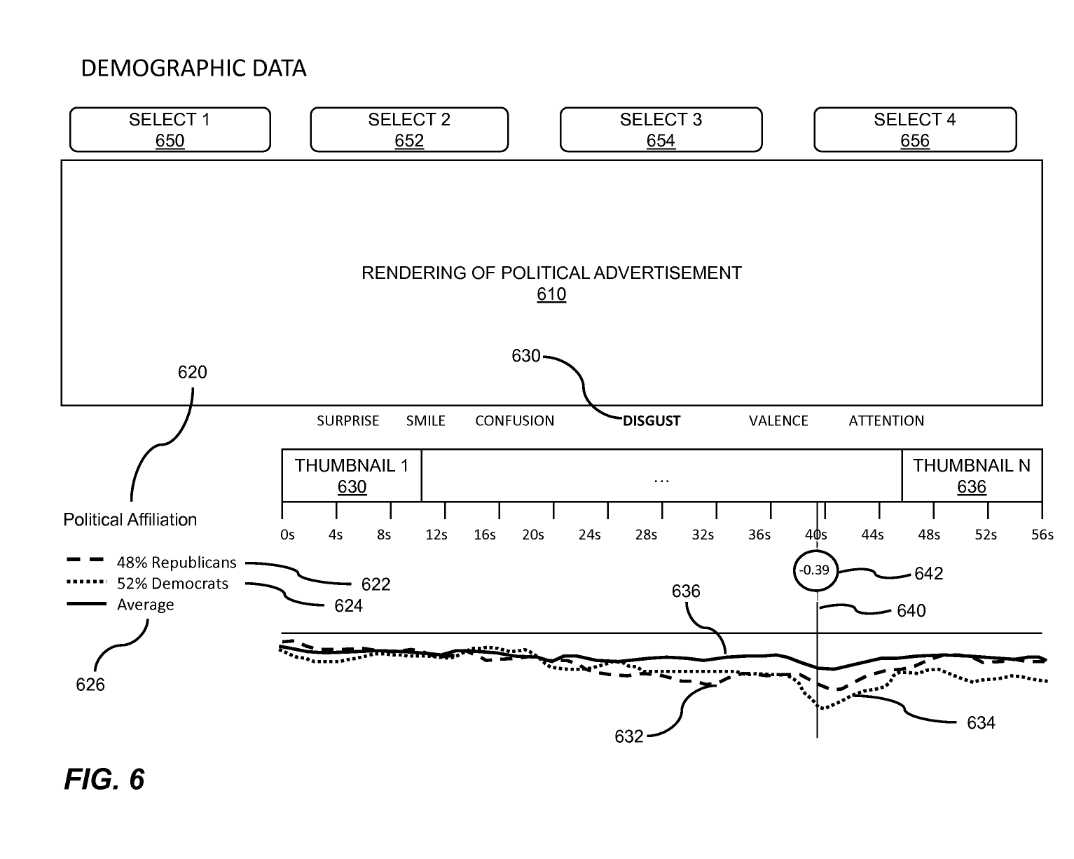

FIG. 6 is a graphical rendering including demographic information. A rendering of a political advertisement 610 is presented. A user may be able to select between a plurality of political advertisements using various buttons such as Select 1 button 650, Select 2 button 652, Select 3 button 654, and Select 4 button 656. Various demographics may be selected for the various renderings, such as political affiliation 620. A group of individuals identified as Republicans 622 and a group of individuals identified as Democrats 624 may be displayed, along with an overall average 626. In embodiments, independent or third party affiliations may be identified. The demographic information may include, but is not limited to, political affiliation, age range, gender, ethnicity, nationality, religious affiliation, level of education, income bracket, and residence information. Thus, the multiple demographic groups may be based on one or more of age, political affiliation, gender, geographic location, and ethnicity. A plurality of thumbnail images, including a first thumbnail 630 through an N^{th} thumbnail 636, may show a graphic “storyboard” of the political advertisement. A line corresponding to each demographic group may be displayed for a given parameter. In FIG. 6, the lowered disgust parameter 630 is shown with lines corresponding to various demographic groups for the selected parameter. In this example, a first line 632 may correspond to democrats, a second line 634 may correspond to republicans, and a third line 636 may correspond to an entire population and not just those affiliated with a political party. In embodiments, aggregated mental state information may be aggregated separately for each of multiple demographic groups and presented.

A cursor line 640 and a time indicator 642 may be used to identify a particular point in time within the political advertisement. In this example, the parameter selected is lowered eyebrows. The lowered eyebrows parameter may be used as an indication of possible confusion or disbelief. A data analyst can track where Republicans lowered their eyebrows and determine which part of the political advertisement caused that response. A similar analysis may be performed for democrats. In this way the data analyst can determine where democrats and republicans may respond differently to various parts of a political advertisement. Hence, embodiments of the present disclosure provide for a testing of messaging, and allow a political advertisement to be “fine tuned” by creating multiple iterations of a political advertisement and testing one or more of the sets of the political advertisement using multiple sets of focus groups.

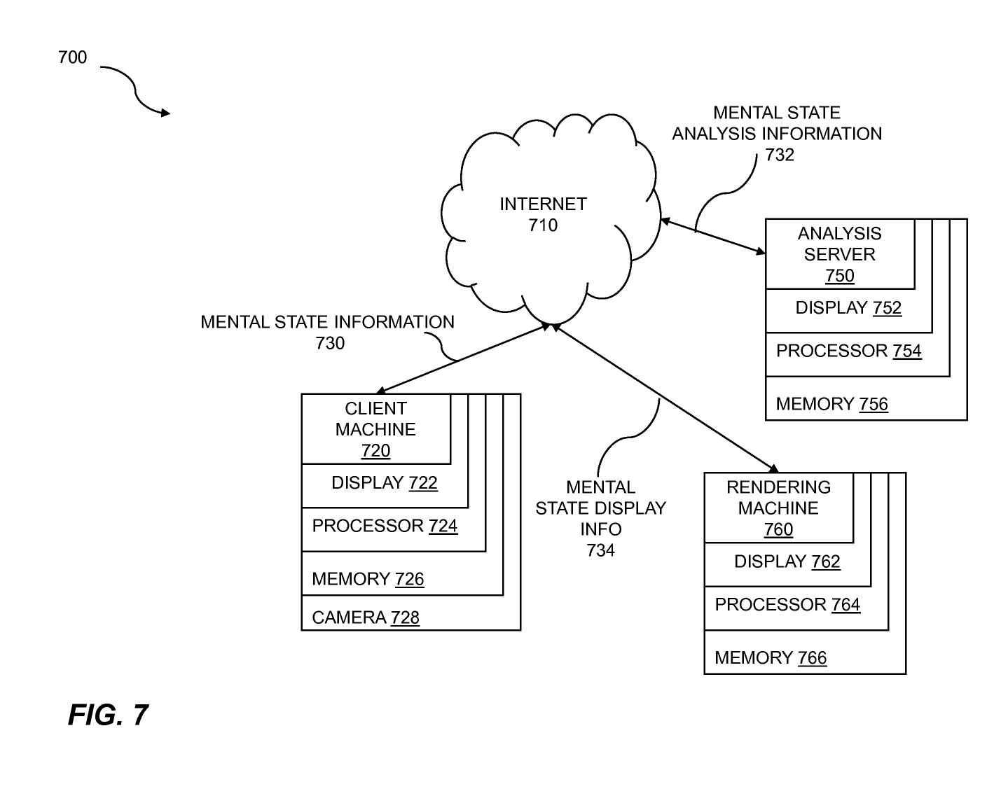

FIG. 7 is a diagram of a system 700 for analyzing political advertisements using multiple computers. The diagram illustrates an example system 700 for mental state collection, analysis, and rendering. The system 700 may include one or more client machines 720 linked to an analysis server 750 via the Internet 710 or other computer network. The example client machine 720 comprises one or more processors 724 coupled to a memory 726 which can store and retrieve instructions, a display 722, and a webcam 728. The memory 726 may be used for storing instructions, mental state data, mental state information, mental state analysis, and political advertisements. The display 722 may be any electronic display, including but not limited to, a computer display, a laptop screen, a net-book screen, a tablet computer screen, a cell phone display, a mobile device display, a remote with a display, a television, a projector, or the like. The webcam 728 may comprise a video camera, still camera, thermal imager, CCD device, phone camera, three-dimensional camera, a depth camera, multiple webcams used to show different views of a person, or any other type of image capture apparatus that may allow captured data to be used in an electronic system. The processors 724 of the client machine 720 are, in some embodiments, configured to receive mental state data collected from a plurality of people to analyze the mental state data to produce mental state information. In some cases, mental state information may be output in real time (or near real time), based on mental state data captured using the webcam 728. In other embodiments, the processors 724 of the client machine 720 are configured to receive mental state data from one or more people, analyze the mental state data to produce mental state information and send the mental state information 730 to the analysis server 750.

The analysis server 750 may comprise one or more processors 754 coupled to a memory 756 which can store and retrieve instructions, and may include a display 752. The analysis server 750 may receive the mental state data and analyze the mental state data to produce mental state information so that the analyzing of the mental state data may be performed by a web service. The analysis server 750 may use mental state data or mental state information received from the client machine 720. This and other data and information related to mental states and analysis of the mental state data may be considered mental state analysis information 732. In some embodiments, the analysis server 750 receives mental state data and/or mental state information from a plurality of client machines and aggregates the mental state information for use in analyzing political advertisements.

In some embodiments, a rendering display of mental state analysis can occur on a different computer than the client machine 720 or the analysis server 750. This computer may be a rendering machine 760 which may receive mental state data 760, mental state analysis information, mental state information, and graphical display information collectively referred to as mental state display information 734. In embodiments, the rendering machine 760 comprises one or more processors 764 coupled to a memory 766 which can store and retrieve instructions, and a display 762. The rendering may be any visual, auditory, or other communication to one or more individuals. The rendering may include an email, a text message, a tone, an electrical pulse, or the like.

The system 700 may include a computer program product embodied in a non-transitory computer readable medium for mental state analysis, the computer program product comprising: code for collecting mental state data from a plurality of people as they observe political advertisements; code for analyzing the mental state data to produce mental state information; code for aggregating mental state information on the plurality of people to produce aggregated mental state information; and code for analyzing the political advertisements based on the aggregated mental state information. The system 700 may perform a computer-implemented method for mental state analysis comprising: collecting mental state data from a plurality of people as they observe political advertisements; analyzing the mental state data to produce mental state information; sending the mental state information on the plurality of people to produce aggregated mental state information and for analysis of the political advertisements based on the aggregated mental state information. The system 700 may perform a computer-implemented method for mental state analysis comprising: receiving mental state information from a plurality of people based on their observations of political advertisements; aggregating the mental state information on the plurality of people to produce aggregated mental state information; and analyzing the political advertisements based on the aggregated mental state information. The system 700 may perform a computer-implemented method for mental state analysis comprising: receiving aggregated mental state information and analysis of political advertisements, based on the aggregated mental state information collected from a plurality of people; and rendering an output based on the analysis of political advertisements. In at least one embodiment, a single computer may incorporate the client, server, analysis, and/or rendering functions.

Each of the above methods may be executed on one or more processors on one or more computer systems. Embodiments may include various forms of distributed computing, client/server computing, and cloud based computing. Further, it will be understood that for each flowchart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which may be generally referred to herein as a “circuit,” “module,” or “system.”

A programmable apparatus that executes any of the above mentioned computer program products or computer implemented methods may include one or more processors, microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM), Flash, MRAM, FeRAM, phase change memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

What is claimed is:

1. A computer implemented method for voter analysis comprising:
collecting mental state data from a plurality of people as they observe political advertisements;
analyzing the mental state data to produce mental state information;
aggregating mental state information on the plurality of people to produce aggregated mental state information; and
analyzing the political advertisements based on the aggregated mental state information.

2. The method of claim 1 further comprising clustering responses, to the political advertisements, from the plurality of people based on one or more of candidate preference, political affiliation, or political leanings.

3. The method of claim 1 wherein the analyzing the political advertisements includes analysis based on demographics.

4. The method of claim 3 further comprising selecting an advertisement from the political advertisements based on the mental state information and the demographics.

5. The method of claim 4 further comprising exposing the advertisement to a second population of people.

6-7. (canceled)

8. The method of claim 1 further comprising identifying similarities between the plurality of people and a second population of people.

9. The method of claim 8 wherein the similarities are based on an emotional profile.

10. The method of claim 8 wherein the identifying of similarities is for a subset of the plurality of people and the second population of people.

11. (canceled)

12. The method of claim 8 further comprising anticipating a set of responses for the second population.

13. The method of claim 1 wherein the mental state information from one or more people from the plurality of people is shared across a social network.

14. The method of claim 1 further comprising inferring mental states based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity.

15. (canceled)

16. The method of claim 1 wherein the mental state data includes one of a group comprising facial data, physiological data, and accelerometer readings.

17. The method of claim 16 wherein the facial data further comprises head gestures.

18. The method of claim 16 wherein the facial data include information on one or more of action units, head gestures, smiles, brow furrows, squints, lowered eyebrows, raised eyebrows, and attention.

19. The method of claim 16 wherein a webcam is used to capture one or more of the facial data and the physiological data.

20. (canceled)

21. The method of claim 16 wherein a camera is used to capture the mental state data on multiple people from the plurality of people.

22. The method of claim 16 wherein the physiological data includes one of a group comprising electrodermal activity, heart rate, heart rate variability, blink rate, and respiration.

23-24. (canceled)

25. The method of claim 1 wherein the aggregated mental state information allows evaluation of a collective mental state of the plurality of people.

26. The method of claim 1 wherein the aggregated mental state information is aggregated for multiple demographic groups and the multiple demographic groups include one or more of age, political affiliation, gender, geographic location, income, education, and ethnicity.

27. The method of claim 1 further comprising rendering an output based on the mental state information.

28. The method of claim 27 wherein rendering includes highlighting portions of the political advertisements based on the mental state data collected.

29-31. (canceled)

32. The method of claim 1 further comprising tracking of eyes to identify a portion of the political advertisements for which the mental state data is collected.

33. The method of claim 1 further comprising analyzing election behavior for the plurality of people on which mental state data was collected.

34-35. (canceled)

36. The method of claim 1 further comprising predicting an advertisement effectiveness for the political advertisements and comparing the predicted advertisement effectiveness with actual voting.

37. The method of claim 36 further comprising developing norms based on a plurality of advertisements and where the norms are used in the predicting.

38. The method of claim 1 further comprising optimizing a political advertisement based on the mental state information.

39. The method of claim 38 wherein the optimizing includes optimizing the political advertisement for a mobile platform.

40. The method of claim 38 wherein the optimizing the political advertisement is based on multiple viewings by the plurality of people of the political advertisement.

41-43. (canceled)

44. A computer program product embodied in a non-transitory computer readable medium for mental state analysis, the computer program product comprising:
code for collecting mental state data from a plurality of people as they observe political advertisements;
code for analyzing the mental state data to produce mental state information;
code for aggregating mental state information on the plurality of people to produce aggregated mental state information; and
code for analyzing the political advertisements based on the aggregated mental state information.

45. A computer system for mental state analysis comprising:
a memory which stores instructions;
one or more processors attached to the memory wherein the one or more processors, when executing the instructions which are stored, are configured to:
collect mental state data from a plurality of people as they observe political advertisements;
analyze the mental state data to produce mental state information;
aggregate mental state information on the plurality of people to produce aggregated mental state information; and
analyze the political advertisements based on the aggregated mental state information.
